(19) United States
(12) Patent Application Publication
(10) Pub. No.: US 2012/0034441 A1
(43) Pub. Date: Feb. 9, 2012

(54) Composition for forming wet fiber based composite materials

(76) Inventors: Leonard Adzima, Pickerington, OH (US); Paul R. Krumlauf, Thornville, OH (US); William G. Hager, Westerville, OH (US); Jocelyn M. Seng, Granville, OH (US); Ralph D. McGrath, Granville, OH (US); Kevin S. Guigley, Hernando, MS (US); Yadollah Delaviz, Lewis Center, OH (US); Fatemeh Nassreen Olang, Granville, OH (US); Yihsien H. Teng, Westerville, OH (US)

(21) Appl. No.: 11/918,591

(22) PCT Filed: Apr. 12, 2006
(86) PCT No.: PCT/US2006/013954

§ 371 Date: Aug. 17, 2011

Related U.S. Application Data
(60) Provisional application No. 60/671,843, filed on Apr. 15, 2005.

(51) Int. Cl. B32B 13/02; B32B 5/28; C04B 14/42; C04B 26/04; C04B 26/18; C04B 26/14; C04B 7/04; C04B 26/06; B32B 5/16; C04B 26/12

(52) U.S. Cl. 428/219; 428/195.1; 428/294.7; 524/2; 524/6; 524/5; 523/401

(57) ABSTRACT

A wet fiber based composition that includes wet glass fibers, a water dispersible polymeric resin, and gypsum is provided. Components including melamine formaldehyde, a filler material, coupling agents, acetic acid, an accelerator, and/or a hardener may also be added to the composition. The gypsum may be a-gypsum, B-gypsum, or combinations thereof. The wet glass fibers are wet chopped glass fibers or a wet continuous roving. The combination of the wet glass fibers, the water dispersible polymeric resin, and the gypsum have a synergistic effect that creates a composite product that is water resistant, fire resistant, and has improved mechanical properties. In one exemplary embodiment, the wet fiber based composition is used to form a gypsum board that can be molded into various composite products. In other exemplary embodiments, thin multi-ply gypsum boards may be formed by alternately layering glass mats with layers of a gypsum/polymer slurry.

### TECHNICAL FIELD AND INDUSTRIAL APPLICABILITY OF THE INVENTION

The present invention relates generally to composite articles, and more particularly, to a wet fiber based composition for forming reinforced composite articles. Composite articles formed from the wet fiber based composition are also provided.

### BACKGROUND OF THE INVENTION

Wall boards formed of a gypsum core sandwiched between facing layers are commonly used in the construction industry as internal walls and ceilings for both residential and commercial buildings. Facing materials advantageously contribute flexibility, nail pull resistance, and impact strength to the materials forming the gypsum core. In addition, the facing material can provide a fairly durable surface and/or other desirable properties (such as a decorative surface) to the gypsum board. The gypsum core typically contains gypsum, optionally some wet chopped glass fibers, water resistant chemicals, binders, accelerants, and low-density fillers. It is known in the art to form gypsum boards by providing a continuous layer of a facing material, such as a fibrous veil, and depositing a gypsum slurry onto the bottom surface of the facing material. A second continuous layer of facing material is then applied to the top surface of the gypsum slurry. The sandwiched gypsum slurry is then sized for thickness and dried to harden the gypsum core and form a gypsum board. Next, the gypsum board may be cut to a predetermined length for end use.

Glass fibers are commonly used in the production of gypsum wall boards to improve the tensile and tear strength of the products. The fibers may be employed in many forms, including individual fibers, strands containing a plurality of fibers, and rovings. These fiber products, in turn, may be used in discrete form or they may be assembled into woven or non-woven fabrics or mats and incorporated into a gypsum matrix. Alternatively, the fibrous mats may be used as the facing material. For example, glass fibers may be formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected as wet chopped fiber strands.

The wet chopped fibers may then be used in wet-laid processes in which the wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. Next, the slurry containing the fibers is deposited onto a moving screen where a substantial portion of the water is removed to form a web. A binder is then applied, and the resulting mat is dried to remove any remaining water and to cure the binder. The formed non-woven veil is an assembly of dispersed, randomly-oriented individual glass filaments.

It has become commonplace in the industry to utilize such fibrous, wet-laid, non-woven veils as facing materials for gypsum wall boards. Glass fiber facings provide increased dimensional stability in the presence of moisture, biological resistance, and greater physical and mechanical properties than conventional gypsum boards faced with paper or other cellulosic facing materials. In addition, gypsum is the major component of gypsum/cellulose fiber composite boards and products. U.S. Pat. No. 5,100,474 to Hawkins describes a glass-reinforced plaster composition that includes a settable mix composed of 55-65% by weight of a gypsum plaster, 20-30% by weight of a mix of a water-based phenol formaldehyde resin, 3-5% by weight of an acid hardener, and greater than 10% by weight of a fiber reinforcement (glass fibers).

Certain properties of gypsum make it very popular for use in making industrial and building products and molding materials. For example, gypsum is a plentiful and generally inexpensive raw material which, through a process of dehydration and rehydration, can be cast, molded, or otherwise formed into useful shapes. In addition, gypsum-based materials can be shaped, molded, and processed within a short period of time due to gypsum's rapid setting and hardening characteristics. Moldable or molding compounds can be formed from materials that include gypsum. For example, U.S. Pat. No. 3,944,515 to Foley et al. discloses a phenolic molding composition that includes phenol, formaldehyde, Portland cement, urea, gypsum, alumina, zinc stearate, and ice.

This composition is then co-deposited with glass fibers to form sheet molding compounds. In U.S. Pat. No. 5,288,775 to Bischoff et al., a moldable structural building composite is disclosed. The composition used to form the moldable composite includes an acrylic polymer (FORTON VF 812), a-gypsum, natural cellulose fibers, a filler material, and optionally a hardening agent (ammonium chloride) and melamine formaldehyde. It is preferred that the cellulose fibers are soaked with a mixture of the acrylic polymers and water so that the fibers are well soaked and impregnated with the acrylic material. U.S. Pat. No. 4,355,128 to Mercer discloses the formation of durable molded articles through a process of (1) mixing a 25-90% by weight of a hardenable resin system, 3-60% by weight of a gypsum filler, and 1-15% by weight of glass fibers, (2) molding the mixture into a desired article, and (3) hardening the molded article by heat or by the use of a hardening agent. The hardenable resin system includes at least one hardenable resin such as urea formaldehyde and may optionally include a second hardenable resin such as a polyvinyl acetate resin. The proportions of the components of the resin system are chosen to impart desired surface finishes to the molded product.

Despite the existence of gypsum wallboards, there remains a need in the art for an improved gypsum board that is low cost, demonstrates improved water resistance, improved mechanical properties, and is at least comparably fire resistant.

### SUMMARY OF THE INVENTION

It is an object of the present invention to provide a wet fiber based composition that includes wet glass fibers, a polymeric resin that is dispersible in water, and gypsum.

Additional components including a crosslinking agent such as melamine formaldehyde, a filler material, coupling agents, acetic acid, an accelerator, and/or a hardener may be added to the composition. The wet glass fibers utilized in the composition may be wet chopped glass fibers or a wet continuous roving. Wet glass fibers are a low cost reinforcement that provide impact resistance, dimensional stability, and improved mechanical properties such as improved strength and stiffness to the finished composite product. Wet used chopped strand glass fibers have an additional advantage of being easily mixed and may be fully dispersed in the composition. Suitable examples of polymeric resins for use in the composition include acrylic based polymers, polyester emulsions, vinylacetate emulsions, epoxy emulsions, and phenolic based polymers. The polymer may or may not be self-crosslinking. An additional polymer such as melamine-formaldehyde or urea-formaldehyde, which act as crosslinking agents, may be added to assist in the crosslinking reaction, regardless of whether or not the polymer is self-crosslinking. The polymeric resin provides strength, flexibility, toughness, durability, and water resistance to the final product. The gypsum may be α-gypsum, β-gypsum, or combinations thereof. The gypsum absorbs water and provides a fire resistance property to the final composite.

It is another object of the present invention to provide a glass fiber reinforced gypsum composite product (such as a gypsum board) formed from the wet fiber based composition described above. The gypsum board may be formed by applying a layer formed of the wet glass fiber based composition into half of a mold to take the desired or predetermined shape of the board (or other composite product). The mold may be at least partially coated with a releasing agent, such as a wax, to enable the board to be easily removed after the curing process has been completed. In addition, the mold may be pre-treated with a polymer gypsum pre-coat to assist with the easy removal of the component or article and to create a smooth finish on the surface. In the final product, the chopped glass fibers are substantially evenly distributed. The gypsum board may include a patterned surface, such as wood grain or other aesthetically pleasing surface. It is to be appreciated that the inventive wet fiber based gypsum composition enables the gypsum board to easily pick up a design or pattern. In addition, the surface of the gypsum board may be provided with a paint, stain, or protective sealer to enhance the aesthetics or the weatherability of the board. The gypsum board is extremely water resistant due to the polymer resin in the inventive composition and possesses high mechanical properties due to the presence of the wet used chopped strand glass fibers.

It is yet another object of the present invention to provide a thin glass reinforced gypsum drywall material. A one-ply, thin gypsum drywall board may be formed from a wet glass fiber layer sandwiched between two layers of a moldable polymer/gypsum slurry (modified gypsum board). A thin multilayered or multi-ply drywall board may be formed by alternately layering additional layers of the wet glass fibers and the moldable polymer/gypsum slurry. The wet glass fiber layer is formed of wet glass fibers and may be a wet formed mat that includes wet used chopped strand glass fibers (WUCS). Preferred mats for use as the glass layer include WUCS-based shingle mats available from Owens Corning (Toledo, Ohio, USA) with weights between about 0.5 and about 5.0 lb/100 sq. ft. The thin drywall board and the thin multilayered drywall board may be used as replacements for conventional gypsum boards. Unlike conventional drywall boards, the thin gypsum drywall boards have advantages of being lightweight, having increased strength, increased impact resistance, and increased water resistance. Additionally, the gypsum drywall boards (both one-ply and multi-ply) are thinner than conventional drywall boards and can achieve similar properties at lower weights. Similar to the gypsum board described above, the one-ply gypsum drywall board and the thin multilayered drywall board may include a patterned surface, such as wood grain, to provide enhanced aesthetics.

It is an advantage of the present invention that the wet glass fiber formulation of the present invention imparts improved physical properties, such as increased strength, stiffness, and impact resistance, to the finished composite product.

It is an additional advantage of the present invention that the wet used chopped strand glass fibers (WUCS) are a low cost reinforcement that provides impact resistance, dimensional stability, and improved mechanical properties such as improved strength and stiffness to the finished composite product. In addition, with WUCS, the final composite product is compatible with fastening systems such as nails, staples, and screws utilized in construction processes and reduces the occurrence of cracking and other mechanical failures.

It is another advantage of the present invention that WUCS fibers are easily mixed and may be fully dispersed in the wet glass fiber composition.

It is a further advantage of the present invention that the wet glass fiber composition is Class A fire resistant. Not only the presence of glass fibers in the gypsum but also the gypsum itself provides fire resistance to the composite product. This Class A fire rating mean that a composite product formed from the inventive wet glass fiber composition will not support the spread or propagation of flames.

It is also an advantage of the present invention that the polymeric resin provides strength, flexibility, toughness, durability, and water resistance to the final product. In particular, combinations of melamine-formaldehyde resin and acrylic resin produce good quality coatings and give good weather resistance, water resistance, and chemical resistance to the final composite product.

It is yet another advantage of the present invention that inventive wet fiber based gypsum composition enables a gypsum board formed of the composition to easily pick up a design or pattern.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a gypsum board according to at least one exemplary embodiment of the present invention;

FIG. 2 is a schematic illustration of a shaped gypsum board according to at least one exemplary embodiment of the present invention;

FIG. 3 is a schematic illustration of conventional gypsum drywall board;

FIG. 4 is a schematic illustration of a one-ply thin gypsum wallboard according to at least one exemplary embodiment of the present invention;

FIG. 5 is a schematic illustration of a multilayered gypsum wallboard according to at least one exemplary embodiment of the present invention; and

FIG. 6 is a graphical illustration of Gardner impact testing on an inventive composite siding board, a vinyl siding product, and a fiber/cement siding product.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein.

In the drawings, the thickness of the lines, layers, and regions may be exaggerated for clarity. It is to be noted that like numbers found throughout the figures denote like elements. The terms “top”, “bottom”, “side”, “upper”, “lower” and the like are used herein for the purpose of explanation only. It will be understood that when an element is referred to as being “on,” another element, it can be directly on or against the other element or intervening elements may be present. The terms “formulation” and “composition” may be used interchangeably herein. In addition, the terms “polymer” and “polymeric resin” may be used interchangeably. Further, the terms “filler” and “filler material” may be interchangeably used herein.

The present invention relates to a wet fiber based composition and reinforced composite products formed therefrom. The wet fiber based composition utilized to form a reinforced composite product that includes wet glass fibers, a polymeric resin that is dispersible in water, and gypsum. The combination of these three components have a synergistic effect which creates a final composite product that is water resistant, fire resistant, and has improved mechanical properties. Additives such as a density reducing filler material and coupling agents may be added to the composition. Other materials may be used in the composition depending on the chosen processing method and ultimate use of the composite article.

The wet glass fibers utilized in the composition may be wet chopped glass fibers or a wet continuous fiber such as a wet continuous roving. As used herein, the term “continuous fibers” is meant to include not only fibers that are practically indefinite in length but also fibers that are not intentionally chopped into discrete lengths. Glass fibers such as A-type glass, C-type glass, E-type glass, R-type glass, S-type glass, or ECR-type glass such as Owens Corning's Advantex® (commercially available from Owens Corning (Toledo, Ohio, USA)) glass fibers may be used in the composition. Preferably, the wet glass fibers are formed of E-type glass, S-type glass, ECR-type glass, or an alkaline resistant glass. In at least one preferred embodiment, the wet glass fibers are wet used chopped strand glass fibers (WUCS). Wet used chopped strand glass fibers may be formed by conventional processes known in the art. It is desirable that the wet glass fibers have a moisture content from about 5 to about 30%, and even more desirably a moisture content of from about 10 to about 20%.

WUCS fibers are a low cost reinforcement that provides impact resistance, dimensional stability, and improved mechanical properties such as improved strength and stiffness to the finished composite product. Further, with WUCS, the final composite product has the mechanical properties to take nails and screws in construction processes without cracking or other mechanical failures. In addition, WUCS fibers are easily mixed and may be fully dispersed or nearly fully dispersed in the composition. It is to be noted that although the glass fibers disperse well in the composition, unlike conventional dry-glass reinforced gypsum formulations, a large amount of wet glass fibers are not needed to achieve improved impact resistance and improved mechanical properties. Wet glass fibers such as WUCS or wet continuous rovings are pre-hydrated and include a substantial amount of water that may be absorbed into the gypsum crystal structure, which causes the gypsum in the composition to harden without the application of heat. This is opposite of the conventional reinforcement fibers used in reinforced gypsum products in which the conventional fibers reinforcements must be dried before use, thereby creating an extra processing step and extra cost. Therefore, the wet glass fibers of the present invention bring a processing advantage as well as an economic advantage.

The wet glass fibers may have a diameter from about 5 microns to about 25 microns, preferably from about 12 microns to about 19 microns. If the wet glass fibers are chopped fibers such as WUCS, they may have a length of about ⅛ inches to about 2 inches and preferably a length of about ¼ inches to about ¾ inches. The wet glass fibers may be present in the composition in an amount from about 1.0% to about 25% by weight of the active solids in the composition, preferably from about 5.0% to about 10% by weight of the active solids. Additionally, the wet glass fibers are typically at least partially coated with a chemical size composition that includes one or more film forming agents (such as a polyurethane film former, a polyester film former, and/or an epoxy resin film former), at least one lubricant, and at least one silane coupling agent (such as an aminosilane or methacryloxy silane coupling agent) in an amount from about 0.01 to 0.2 percent by weight.

In addition to wet glass fibers, the wet glass fiber based composition includes one or more polymeric resins that are at least partially dispersible in water, and most preferably, fully dispersible in water. The polymeric resin provides strength, flexibility, toughness, durability, and water resistance to the final product. The polymer may be in the form of a liquid, an emulsion, and/or a powder. The polymeric resin is not particularly limited, so long as it is at least partially water dispersible. The polymer may or may not be self-crosslinking. An additional polymer such as melamine-formaldehyde or urea-formaldehyde, which act as crosslinking agents, may be added to assist in the crosslinking reaction, regardless of whether or not the polymer is self-crosslinking. However, it is to be appreciated that if the polymer is not self-crosslinking, a crosslinking agent such as melamine-formaldehyde is desirably added to catalyze and assist in the crosslinking reaction.

The crosslinking reaction may occur slowly over time at atmospheric conditions (typically over a period of approximately two weeks). As the crosslinking between the polymer occurs and a polymeric network is formed around the gypsum, the molecular weight of the polymer increases. As the molecular weight of the polymer increases, the composition becomes more rigid. The crosslinking reaction may be accelerated upon heating the composition to a moderate temperature, such as to a temperature between about 140 ° F. to about 160 ° F. (between about 60° C. to about 71° C.), for a predetermined period of time. It is preferred, however, that the crosslinking reaction be permitted to occur over time at room temperature. It is also to be noted that in addition to the polymer crosslinking, the wet glass fibers may chemically react with the polymer(s) and bond thereto due to coupling agents previously adhered to the glass fibers in a sizing composition.

Suitable polymeric resins for use in the composition may include, but are not limited to, acrylic based polymers, polyester emulsions, vinylacetate emulsions, epoxy emulsions, and phenolic based polymers. Specific examples of polymers that may be used in the glass fiber based composition include polyvinyl alcohol (PVA), polyvinyl chloride (PVC), chlorinated polyvinyl chloride (CPVC), polyethylene, polypropylene, polycarbonates, polystyrene, styreneacrylonitrile, acrylonitrile butadiene styrene, acrylic/styrene/acrylonitrile block terpolymer (ASA), polysulfone, polyurethane, polyphenylenesulfide, acetal resins, polyamides, polyaramides, polyimides, polyesters, polyester elastomers, acrylic acid esters, copolymers of ethylene and propylene, copolymers of styrene and butadiene, copolymers of vinylacetate and ethylene, and combinations thereof. In addition, the polymeric resin may be post industrial or consumer grade (regrind).

Preferred polymers come from the family of acrylic latexes. Acrylic monomers used to make acrylic latexes include methyl acrylate, ethyl acrylate, butyl acrylate, and acrylic acid. Combinations of these monomers may be emulsion polymerized to make acrylic resins. These polymers typically contain hydroxyethyl acrylate monomers to impart hydroxyl groups along the polymer chain. These hydroxyl containing polymers are called thermoset acrylics. The acrylic (R-OH) permits crosslinking with other polymers such as melamine-formaldehyde or urea-formaldehyde. The crosslinking occurs through both hydroxyl and ether groups in the melamine-formaldehyde, and are catalyzed by an acid. Acids and acid producing agents such as p-toluenesulfonic acid and ammonium chloride, which forms hydrochloric acid, are suitable catalysts for the crosslinking reaction. Combinations of melamine-formaldehyde resin and acrylic resin produce good quality coatings and give good weather resistance, water resistance, and chemical resistance to the final composite product. The use of these polymers allows the composite product formed by the composition of the present invention to be manufactured without styrene and the requisite environmental controls. The polymeric resin(s) may be present in the composition in an amount from about 4.0% to about 40% by weight of the active solids in the composition, preferably from about 10% to about 30% by weight of the active solids.

A third component of the inventive composition is gypsum. Gypsum, also know as calcium sulfate dihydrate (CaSO₄·2 H₂O), is a natural mineral derived from the earth. When calcined, three quarters of the water of crystallization is driven off to produce calcium sulfate hemihydrate (CaSO₄·½ H₂O). If the calcination is carried out under pressure, an α-form of gypsum is produced. α-gypsum has regular, needle (acicular), or rod shaped particles. On the other hand, if the calcination is conducted at atmospheric pressure, a β-form of gypsum is produced with porous, irregularly-shaped particles. Although the gypsum used in the inventive composition may be α-gypsum, β-gypsum, or combinations thereof, β-gypsum is more preferred due to its lower cost and increased ability to absorb water as compared to α-gypsum. One advantage of gypsum-based materials in general is that gypsum-based materials can be shaped, molded, and processed within a short period of time due to gypsum's naturally occurring rapid setting and hardening characteristics. In addition, the gypsum provides a fire resistance property to the final composite. In the inventive composition, the gypsum absorbs the water in the wet glass fibers and goes from a partially hydrated state (naturally occurring state) to a fully hydrated state and hardens. Gypsum may be present in the wet glass fiber based formulation in an amount from about 30% to about 70% by weight of the active solids in the composition, preferably from about 40% to about 60% by weight of the active solids.

Additional components may be added to the composition to modify properties of the final composite part or they may be added because of the specific process being used to form the final composite part. For example, low density fillers may be added to reduce the cost, the overall density of the final composite product, and may also be used as an extender. Non-limiting examples of suitable fillers that may be used in the composition include perlite (expanded perlite), calcium carbonate, sand, talc, vermiculite, aluminum trihydrate, recycled polymer materials, microspheres, microbubbles, wood flour, natural fibers, clays, calcium silicate, graphite, kaolin, magnesium oxide, molybdenum disulfide, slate powder, zinc salts, zeolites, calcium sulfate, barium salts, diatomaceous earth, mica, wollastonite, expanded shale, expanded clay, expanded slate, pumice, round scrap glass fibers, flaked glass, nano-particles (such as nano-clays, nano-talcs, and nano-TiO₂), and/or finely-divided materials that react with calcium hydroxide and alkalis to form compounds possessing cementitious properties such as fly ash, coal slag, and silica. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof.

The presence of at least one coupling agent in the formulation may also provide added desirable attributes. For example, the presence of a coupling agent helps to bond the organic (polymeric resin) and inorganic (glass fibers) portions of the composition. In particular, the addition of a coupling agent to the composition increases the bond strength between the wet glass fibers and the polymer. Silane coupling agents are preferred due to their ability to distribute quickly into water. Examples of silane coupling agents that may be used in the present size composition may be characterized by the functional groups amino, epoxy, vinyl, methacryloxy, ureido, and isocyanato. In preferred embodiments, the silane coupling agents include silanes containing one or more nitrogen atoms that have one or more functional groups such as amine (primary, secondary, tertiary, and quaternary), amino, imino, amido, imido, ureido, or isocyanato. Suitable silane coupling agents include, but are not limited to, aminosilanes, silane esters, vinyl silanes, methacryloxy silanes, epoxy silanes, sulfur silanes, ureido silanes, and isocyanato silanes. When silane coupling agents are used, a small amount of an organic acid (such as acetic acid, formic acid, succinic acid, and/or citric acid) may be added to regulate the pH of the composition, preferably to a pH of about 4 to about 5.5. Acetic acid is the most preferred organic acid for use in the inventive composition.

Specific non-limiting examples of silane coupling agents for use in the inventive composition include γ-aminopropyltriethoxysilane (A-1100), n-trimethoxy-silyl-propyl-ethylene-diamine (A-1120), and γ-glycidoxypropyltrimethoxysilane (A-187). Other non-limiting examples of suitable silane coupling agents are set forth in Table 1. All of the coupling agents identified above and in Table 1 are available commercially from GE Silicones.

TABLE 1

| Silanes | Label |
|---|---|
| Silane Esters | |
| octyltriethoxysilane | A-137 |
| methyltriethoxysilane | A-162 |
| methyltrimethoxysilane | A-163 |
| Vinyl Silanes | |
| vinyltriethoxysilane | A-151 |
| vinyltrimethoxysilane | A-171 |
| vinyl-tris-(2-methoxyethoxy) silane | A-172 |
| Methacryloxy Silanes | |
| γ-methacryloxypropyl-trimethoxysilane | A-174 |
| Epoxy Silanes | |
| β-(3,4-epoxycyclohexyl)- | A-186 |
| ethyltrimethoxysilane | |
| Sulfur Silanes | |
| γ-mercaptopropyltrimethoxysilane | A-189 |
| Amino Silanes | |
| γ-aminopropyltriethoxysilane | A-1101 |
| | A-1102 |
| aminoalkyl silicone | A-1106 |
| γ-aminopropyltrimethoxysilane | A-1110 |
| triaminofunctional silane | A-1130 |
| bis-(γ-trimethoxysilylpropyl)amine | A-1170 |
| polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

Preferably, the silane coupling agent is an aminosilane or a diaminosilane. The coupling agent may be present in the composition in an amount from about 0% to about 5.0% by weight of the active solids in the composition, preferably from about 0.1% to about 1.0% by weight of the active solids.

An accelerator may be added to the composition to increase the rate at which the gypsum hardens or sets. A preferred accelerator is aluminum sulfate. However, any suitable accelerator identifiable by one skilled in the art may be used, such as, for example, potassium sulfate, terra alba, sodium hexafluorosilicate, sodium chloride, sodium fluoride, sodium sulfate, magnesium sulfate, and magnesium chloride. The accelerator may be present in the composition in an amount up to about 1.0% by weight of the active solids in the composition. It is to be appreciated that the amount or quantity of accelerator added to the composition may dramatically affect how quickly the gypsum hardens. For example, a large amount of accelerator added to the composition will cause the gypsum to set more quickly than if a smaller amount of accelerator were added to the composition. In other words, a larger amount of accelerator will more quickly increase the speed at which the gypsum hardens compared to a smaller amount of added accelerator.

In addition, a hardener or hardening agent such as ammonium sulfate or ammonium chloride may be added to the composition to increase both the rate of crosslinking and the crosslink density. The hardener may be present in the composition in an amount up to about 1.0% by weight of the active solids in the composition.

Additional additives such as dispersants, antifoaming agents, viscosity modifiers, and/or other processing agents may be added to the composition depending on the desired process and/or use of the final composite product.

To create a mixture formed from the inventive composition that may be utilized to form a final composite part, the dry components of the composition, such as, for example, melamine-formaldehyde, gypsum, and filler (perlite) are dry blended in a container to form a dry mixture. Wet components of the composition, such as any water, the emulsion polymer, and coupling agent(s) are stirred in a second container until they are blended. The dry mixture is slowly added to the wet components in the second container with stirring until all the dry mixture is added and the resulting composition is well blended. The wet glass fibers (wet chopped glass fibers) are added to the composition to form a polymer/gypsum slurry with a high viscosity. The wet glass fibers may be combined with the polymer/gypsum slurry with a mixer or by hand with a spatula to form a composition that has a consistency similar to that of paper-mâché. The amount of water added may vary dramatically based on the manufacturing technique to be used and the desired mechanical properties of the final composite part.

The glass fiber based composition described in detail above can be used in a wide variety of applications, such as, but not limited to, open molding, hand lay-up, filament winding, extrusion processes, pultrusion processes, casting, and doctor blading. In one exemplary embodiment of the invention, a modified gypsum-based article is made by an open mold, hand lay-up process. In lay-up applications, a layer formed of the wet glass fiber based composition may be applied or deposited onto half of a mold to take the shape of the desired product, such as a residential siding product, shaped siding product, interior/exterior trim boards, floor tiles, ceiling tiles, bath tubs, shower stalls, or kitchen surfaces such as countertops, sinks, or basins. After application into the open mold, the composition is rolled out using rollers such as serrated rollers. The mold may be at least partially coated with a releasing agent, such as a wax, which will enable the part to be easily removed after the curing process has been completed. In addition, the mold may be pre-treated with a polymer-gypsum pre-coat to assist with the easy removal of the component or article and to create a smooth finish on the surface. The pre-coat is desirably applied after the releasing agent and may be white or pigmented.

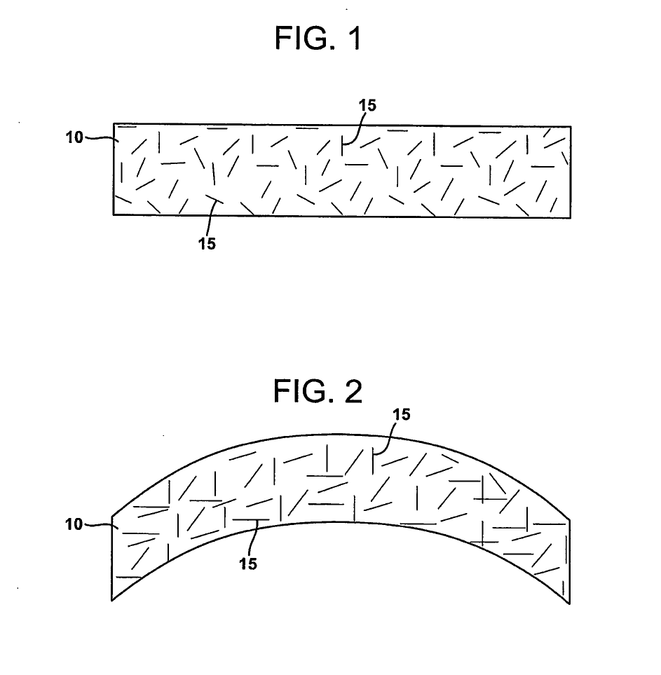

In one particular example of a hand lay-up application, a gypsum board (such as, for example, a siding product) is formed. An exemplary gypsum board 10 formed of the inventive composition is illustrated in FIG. 1. It can be seen in FIGS. 1-2 that the chopped glass fibers 15 are substantially evenly distributed throughout the gypsum board 10. As used herein, the term “substantially evenly distributed” is meant to indicate that the chopped glass fibers are evenly distributed or nearly evenly distributed throughout the gypsum board 10. The gypsum board 10 may be formed substantially straight (as shown in FIG. 1), or it may be formed to have a desired shape. For example, a curved mold may be used to produce a curved gypsum board 10 such as is depicted in FIG. 2. Although not illustrated, it is to be appreciated that the gypsum board 10 may include a patterned surface, such as a wood grain or other aesthetically pleasing surface, to provide enhanced aesthetics, such as in a siding product, in fence deck planks, or in a railing material. The inventive wet fiber based gypsum composition enables the board 10 to easily pick up a design or pattern. The surface of the gypsum board 10 may also, or alternatively, be provided with a post fabrication coating (such as a paint, stain, or protective sealer) to enhance the aesthetics or weatherability of the board 10. The gypsum board 10 is extremely water resistant due to the polymer resin in the inventive composition.

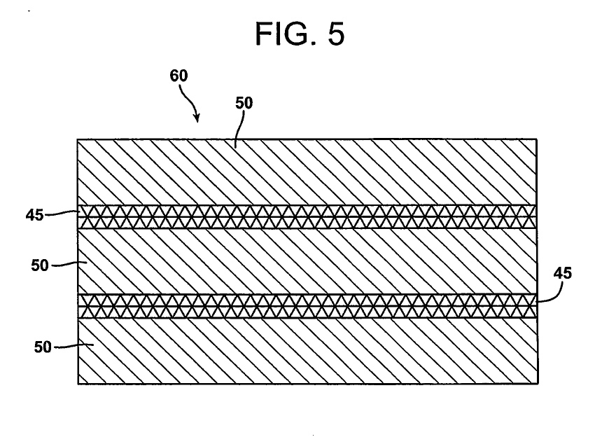

In another application of the invention as depicted in FIGS. 4 and 5, thin gypsum drywall boards may be formed. As illustrated in FIG. 4, a one-ply, thin gypsum drywall board 40 may be formed of a wet glass fiber layer 45 sandwiched between two modified gypsum boards 50. The modified gypsum boards 50 are formed of the polymer/gypsum slurry described in detail above. It is to be noted that the polymer/gypsum slurry does not contain the wet glass fibers. The wet glass fiber layer 45 contains the wet glass fibers and may be in the form of a wet formed mat that includes wet used chopped strand fibers (WUCS). Preferred mats for use as the glass layer 45 include WUCS-based shingle mats available from Owens Corning (Toledo, Ohio, USA) with weights between about 0.5 and about 5.0 lb/100 sq. ft, preferably between about 1.5 and about 2.5 lb/100 sq. ft, more preferably less than about 2 lb/100 sq. ft, and most preferably between about 1.75 lb/100 sq. ft and about 1.95 lb/100 sq. ft. In forming the thin multilayered or multi-ply drywall board 60 illustrated in FIG. 5, multiple layers of the modified gypsum board 50 are alternatively layered with wet glass fiber layers 45.

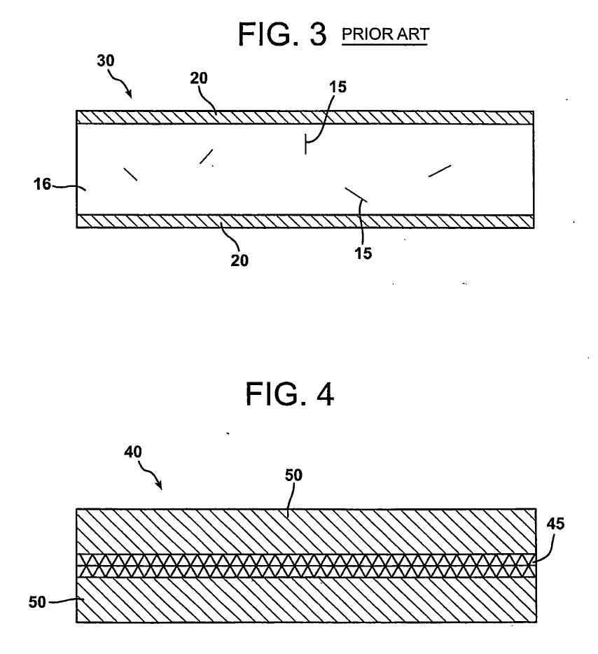

The thin, one-ply drywall board 40 and the thin, multilayered (multi-ply) drywall board 60 may be used as replacements for conventional gypsum boards such as the conventional drywall board 30 depicted in FIG. 3. In conventional drywall boards 30, a gypsum core 16 is positioned between two facing layers 20. The facing layer 20 may be selected from materials that provide desired physical, mechanical and/or aesthetic properties. Examples of materials that may be used as facing layer 20 may include a glass fiber scrim, veil, or fabric, woven or non-woven materials, and paper or other cellulosic items. Facing materials 20 advantageously contribute flexibility, nail pull resistance, and impact strength to the materials forming the gypsum core 16. In addition, the facing material 20 can provide a fairly durable surface and/or other desirable properties such as a decorative surface to the drywall board 30. The gypsum core 16 typically contains gypsum, optionally some wet chopped glass fibers, water resistant chemicals, binders, accelerants, and low-density fillers. It is to be noted, however, that the amount of glass fibers present in the gypsum core 16 is much less (up to approximately 0.2% by weight glass fibers) than the amount of glass fibers utilized in the present invention (approximately 1.0% to about 25% by weight glass fibers), and in at least some instances, the gypsum core 16 does not contain any glass fibers.

Unlike conventional drywall boards 30, the thin, one-ply gypsum drywall board 40 and the thin, multi-ply gypsum drywall board 60 have advantages of being lightweight and having increased strength, increased impact resistance, and increased water resistance.

Additionally, both the one-ply and multi-ply gypsum drywall boards 40, 60 are thinner than conventional drywall boards and can achieve similar advantageous properties at lower weights. Similar to the gypsum board 10 described above, the one-ply gypsum drywall board 40 and the thin multilayered drywall board 60 may include a patterned surface, such as wood grain, to provide enhanced aesthetics. The thin gypsum drywall board 40 and the multi-ply gypsum drywall board 60 may be produced either in-line (in a continuous manner), or off-line. Preferably, the drywall boards 40, 60 are conducted in-line to increase manufacturing efficiency.

In another exemplary embodiment of the present invention (not illustrated), the inventive wet glass based composition is used in a filament winding process. In such an application, a wet continuous roving is dipped in a bath of the polymer/gypsum slurry described in detail above. It is to be appreciated that a dry continuous roving could alternatively be used; however, a wet continuous roving is preferred due to the lower cost of the wet continuous roving. After the wet (or dry) continuous roving has been dipped into the polymer/gypsum slurry bath and a layer of the polymer/gypsum slurry has been substantially deposited thereto, the gypsum/polymer coated continuous roving may then be wound onto a mandrel. As used herein, the term “substantially deposited thereto” is meant to indicate that the polymer/gypsum slurry is deposited in a manner such that the polymer/gypsum slurry completely covers or coats the surface of the continuous roving or that the polymer/gypsum slurry nearly covers or coats the surface of the continuous roving. The mandrel may be any conventional mandrel such as a reusable mandrel, a collapsible mandrel, an integral mandrel, or a sacrificial mandrel. Once the coated continuous roving has been placed about the mandrel, the mandrel is desirably placed in an area (storage area) so that the crosslinking reaction may occur slowly over time at atmospheric conditions. It is possible to heat the mandrel to a moderate temperature (such as described above) to increase the speed of the crosslinking reaction. Once the composite is cured (crosslinked), the mandrel may be removed. Composite parts such as a pipe to be used as an insulative overwrap or as an electrical conduit in which internal electrical wires can be reasonably well protected may be formed by utilizing the wet glass fiber based composition of the present invention in the above-described filament winding process. Such composite parts have improved fire resistance over conventional filament wound pipes.

One advantage of the wet glass fiber composition of the present invention is that the composite product is Class A fire resistant. Not only the presence of glass fibers present in the gypsum but the gypsum itself provides fire resistance to the composite product. This Class A fire rating means that a composite product formed from the inventive wet glass fiber composition will not support the spread or propagation of flames.

In addition, the wet glass fiber formulation of the present invention imparts improved physical properties, such as improved strength, stiffness, and increased impact resistance, to the finished composite product.

The present invention is also advantageous in that the WUCS fibers fully disperse in the composition. This increased dispersion of the wet glass fibers causes a more homogenous structure with enhanced mechanical strengths and fewer visual defects. The wet glass fibers utilized in the inventive composition are also low cost reinforcements, especially when compared to conventional dry fibers, which require extra processing steps. Thus, the use of a wet glass fiber (WUCS or wet glass rovings) provides a lower cost system to achieve the final product.

In addition, WUCS fibers provide impact resistance, dimensional stability, and improved mechanical properties such as improved strength and stiffness to the finished composite product. Further, with WUCS, the final composite product is compatible with fastening systems such as nails, staples, and screws utilized in construction processes and reduces the occurrence of cracking and other mechanical failures.

It is a further advantage of the glass fiber based composition that the composition, once mixed, is moldable. This moldability of the composition allows the inventive composition to be formed into any number of shapes to form composites for numerous desired uses. The final product may also be pigmented, painted, or stained to further enhance the aesthetics.

It is also advantageous that the polymeric resin provides strength, flexibility, toughness, durability, and water resistance to the final product. In particular, combinations of melamine formaldehyde resin and acrylic resin produce good quality coatings and give good weather resistance, water resistance, and chemical resistance to the final composite product.

Having generally described this invention, a further understanding can be obtained by reference to certain specific examples illustrated below which are provided for purposes of illustration only and are not intended to be all inclusive or limiting unless otherwise specified.

### EXAMPLES

### Example 1—Physical and Mechanical Properties of Inventive Composite Siding Product

A 12 foot long fiber reinforced gypsum siding board was formed using the inventive composition shown in Table 2. In particular, gypsum (α-gypsum) and a resin (melamine formaldehyde) were weighed and placed in a bucket. Perlite was weighed and placed in a separate bucket. A hardener (ammonium sulfate) was weighed in a small beaker. Water was weighed in a large bucket. An accelerator (aluminum sulfate), a silane coupling agent (γ-aminopropyltriethoxysilane (A-1100), available from GE Silicones), and acetic acid were added to the water in that order, with stirring in between each addition. Next, a polymer (polyacrylic emulsion) was weighed in a large mixing bucket, placed under a mixer, and the mixer was started. Once the mixer was on, the hardener was added to the mixing bucket, followed by the water/accelerator/silane/acetic acid mixture. The gypsum/resin mixture and perlite were added scoopwise, alternating the scoops between scoops of gypsum/polymer resin mixture and scoops of perlite. The mixer was permitted to run for 2 minutes after all the gypsum/polymer mixture and perlite were added. Wet used chopped strand glass fibers having a diameter of 16 microns, a length of ¼ of an inch, and a water content of about 13% were then added to the mixture with a spatula.

TABLE 2

| Component | % by weight |
|---|---|
| α-gypsum | 35.0-55.0 |
| polyacrylic emulsion | 20.0-40.0 |
| wet used chopped strand glass | 5.0-12.0 |
| melamine-formaldehyde | 3.0-7.0 |
| perlite | 2.0-6.0 |
| silane coupling agent | 0.01-2.0 |
| hardener⁽¹⁾ | 0.05-0.25 |
| acetic acid | 0.01-0.3 |
| water | 0.01-10.0 |
| accelerator⁽²⁾ | 0.1-0.4 |
| Total | 100 |

⁽¹⁾aluminum sulfate
⁽²⁾ammonium sulfate

The composition was used to form a 12 foot siding product. In particular, the inventive composition of Table 2 was placed into a mold and allowed to cure at room temperature for 1 day. The siding product was then demolded and compared to several commercial examples for various physical and mechanical properties.

The data set forth in Table 3 illustrates the variations in density between the siding product formed from the inventive composition (inventive composite board in Table 3) and the commercial products of Examples 1-3. It can be seen from Table 3 that the siding product formed from the inventive composition had the lowest board weight of the commercial products tested. The low board weight of the inventive composite siding product permits the siding product to be easily transported and installed.

TABLE 3

| | | | | Board | | |
|---|---|---|---|---|---|---|
| | Width | Thickness | Length | weight | Density | Density |
| | (in) | (in) | (ft) | (lb) | (g/cm³) | (lb/ft³) |
| Example 1⁽¹⁾ | 7¼ | 5/16 | 12 | 16.7 | 1.41 | 88.3 |
| Example 2⁽²⁾ | 8 | ⅜ | 16 | 15.1 | 0.72 | 45.2 |
| Example 3⁽³⁾ | 8¼ | 5/16 | 12 | 20.6 | 1.54 | 96.0 |
| Inventive | 8 | 5/16-3/32 | 12 | 10.0 | 1.21 | 75.5 |
| Composite | | | | | | |
| Siding | | | | | | |

⁽¹⁾fiber/cement siding product
⁽²⁾oriented strand board formed of wood chips and polymer binders
⁽³⁾fiber/cement siding product

Comparative mechanical testing was also conducted on the inventive siding board, the commercial products of Examples 1-3, and a vinyl siding product (Example 4). Tests were conducted according to ASTM D638 (results set forth in Table 4), ASTM D790 (results set forth in Table 5), and ASTM D4812 and ASTM D570 (results set forth in Table 6).

TABLE 4

| | Tensile Strength | Elastic Modulus | Elongation |
|---|---|---|---|
| ASTM D638 | (psi) | (ksi) | (%) |
| Example 1⁽¹⁾ | 880 | 1110 | 0.21 |
| Example 2⁽²⁾ | 2900 | 820 | 0.51 |
| Example 3⁽³⁾ | 1580 | 1870 | 0.10 |
| Example 4⁽⁴⁾ | 2000 | 240 | 2.00 |
| Inventive | 1410 | 1750 | 0.21 |
| Composite | | | |
| Siding | | | |

⁽¹⁾fiber/cement siding product
⁽²⁾oriented strand board formed of wood chips and polymer binders
⁽³⁾fiber/cement siding product
⁽⁴⁾vinyl siding product

It was noted that despite similar compositions, the two fiber/cement products (Examples 1 and 3) performed quite differently during the mechanical testing. Example 1 had the lowest tensile strength as determined by ASTM D638 (Table 4). In addition, as shown in Table 4, Example 1 demonstrated approximately half the tensile strength of Example 3 (880 psi vs. 1580 psi). The tensile strength of the inventive composite siding fell between the two fiber/cement products (Examples 1 and 3) with a tensile strength of 1410 psi. Although the tensile strength of the inventive composite siding did not possess the highest tensile strength of the tested products, the tensile strength demonstrated (1410 psi) was reasonably good and clearly showed that the inventive siding product is competitive in tensile strength with the other siding products tested. In siding products, the tensile strength is a secondary consideration in determining the quality of the product, as siding is rarely stretched or held in tension and thus does not have a need for a high tensile strength.

The same trend that was noted with respect to the tensile strength testing was observed during the elastic modulus testing. In particular, Example 1 demonstrated the lowest value or least stiffness of the four plank sidings at 1110 ksi, followed by the inventive composite siding at 1750 ksi and Example 3 at 1870 ksi. Example 2 demonstrated the highest tensile strength and lowest elastic modulus in these evaluations. In the elastic modulus (stiffness) testing, the only product tested that had a higher psi than the inventive composite siding was Example 3, a fiber/cement based product. However, unlike the inventive composite siding, the fiber/cement siding products are much heavier, making them harder to transport and install, and are more brittle, which makes them easy to break. On the other hand, the inventive composite siding product is lightweight and easy to both install and transport. Therefore, the results set forth in Table 4 demonstrate that the inventive composite siding product is similar in mechanical strength to the products currently commercially available and would at least be commercially competitive therewith.

TABLE 5

| | |
|---|---|
| As Received | 48 h soak, 25° C. |

| | Flexural | Flexural | Flexural | Flexural |
|---|---|---|---|---|
| | Strength | Modulus | Strength | Modulus |
| ASTM D790 | (psi) | (ksi) | (psi) | (ksi) |
| Example 1⁽¹⁾ | 2020 | 790 | 1370 | 630 |
| Example 2⁽²⁾ | 4750 | 460 | 3170 | 280 |
| Example 3⁽³⁾ | 3350 | 1350 | 2130 | 1040 |
| Example 4⁽⁴⁾ | 3750 | 240 | — | — |
| Inventive | 4020 | 770 | 2920 | 480 |
| Composite | | | | |
| Siding | | | | |

⁽¹⁾fiber/cement siding product
⁽²⁾oriented strand board formed of wood chips and polymer binders
⁽³⁾fiber/cement siding product
⁽⁴⁾vinyl siding product

As shown in Table 5, the fiber/cement siding products (Examples 1 and 3) demonstrated the lowest flexural strength. Example 2, the oriented strand board formed of wood dust and polymer binders, demonstrated the highest flexural strength, with the inventive composite siding falling in the middle. In the flexural strength testing, the only product tested that had a higher flexural strength than the inventive composite siding was Example 2, a wood based product. However, wood based products have several disadvantages to them, including rotting, mildew, termite or other bug infestation, and they are not fire resistant. In fact, a wood based siding product would propagate the spread of fire. On the other hand, the inventive siding product is fire resistant, does not spread fire, and is not subject to animal or insect infestation or mold growth due to the fact that there is no wood in the inventive siding composition.

TABLE 6

| | ASTM D4812 | ASTM D570 |
|---|---|---|
| | Unnotched Izod | Water |
| | Impact | Absorption |
| | (ft-lb) | (%) |
| Example 1⁽¹⁾ | 0.94 | 37.33 |
| Example 2⁽²⁾ | 1.68 | 22.01 |
| Example 3⁽³⁾ | 0.69 | 20.26 |
| Example 4⁽⁴⁾ | 1.00-1.25 | 3-4 |
| Inventive | 3.06 | 0.85 |
| Composite | | |
| Siding | | |

⁽¹⁾fiber/cement siding product
⁽²⁾oriented strand board formed of wood chips and polymer binders
⁽³⁾fiber/cement siding product
⁽⁴⁾vinyl siding product

As shown in Table 6, the inventive composite siding product demonstrated the greatest impact resistance and least water absorption in ASTM tests D4812 and D570, respectively. Examples 1 and 3 (the fiber/cement siding products) exhibited the lowest Izod impact resistance, with values below 1 ft-lb. In terms of water absorption, the inventive composite siding product experienced a weight gain of less than 1% after a 24-h water soak. In contrast, Examples 2 and 3 absorbed approximately 20% and Example 1 absorbed approximately 40%. High impact resistance and low water absorption demonstrate that the inventive composite siding product has superior resistance to impacts such as from hail, free-falling debris (such as is generated from hurricanes), and superior water resistance, which would greatly benefit consumers in a flood plain or in a hurricane-prone geographic area.

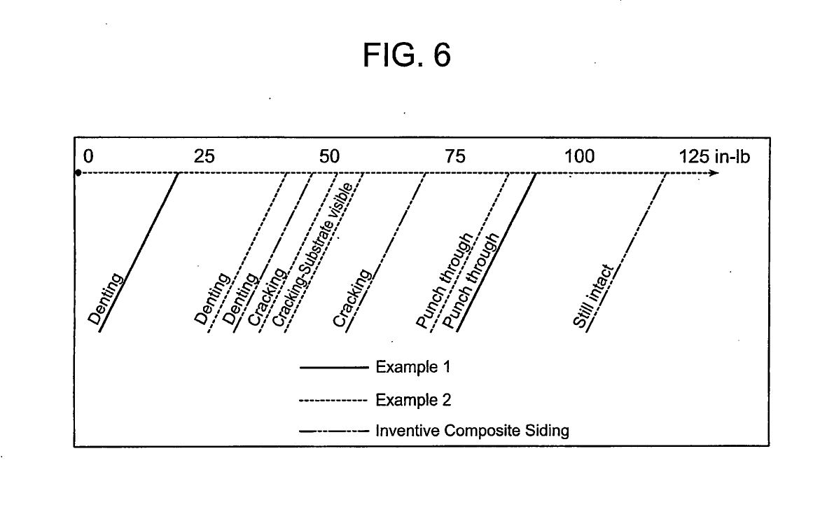

In addition to Izod impact testing, Gardner impact testing was performed for Example 1 (a fiber/cement siding product), Example 2 (a vinyl siding product), and the inventive composite siding product (FIG. 6). A 4-lb weight was used to impact the siding products. The first impact was performed at 15 inches (60 in-lb), and subsequent impacts were performed in increments of 8 in-lb (2 inches). It should be noted that this test, as described in ASTM D4226, is specific to vinyl. Therefore, it relies on visual inspection to determine whether or not failure has occurred. The failure must then be classified as brittle (punched hole, shatter, or crack/split with 0° angle at tip) or ductile (tear/split with non-zero angle at tip). Because the inventive polymer-gypsum system does not fail in the same manner as vinyl, failure in a conventional manner was, somewhat difficult to determine. As a result, instead of a pass/fail or ductile/brittle system, it was noted when denting, cracking, substrate exposure, and punch-through occurred. The results are summarized in FIG. 6.

The data depicted in FIG. 6 is consistent with results from Izod impact testing shown above in Table 6. As shown in FIG. 6, the fiber/cement siding product demonstrated the least impact resistance, showing denting at only 20 in-lb. Example 2 showed denting around 40 in-lb, cracking soon after, and a complete “punch-through” at an approximate 85 in-lb impact. Example 1 was “punched through” at about 90 in-lb. The inventive composite siding product showed significant impact resistance beyond these values. Although it dented around 50 in-lb and cracked at approximately 70 in-lb, the inventive composite siding product remained intact after an approximate 120 in-lb impact.

It is to be appreciated that although flexural strength is an important property in both handling and installation of siding, impact resistance is an important factor in the durability of the siding material, such as to the impact resistance of stray baseballs or golf balls, hail, and/or other debris. The data set forth in Tables 1-6 and in FIG. 6 show that the inventive siding product performs as well as, and in some instances, better than the commercial products tested. As shown above, the inventive siding product possessed the highest water resistance and highest impact resistance. These are two key factors in determining the quality of siding products, because a consumer would be interested in weather resistance (water resistance) and impact resistance (such as impact from hail, baseballs, etc.). Furthermore, the inventive composite siding performed more than adequately in mechanical testing, which is a secondary factor in determining the commercial viability of the siding product.

### Example 2—Fire Testing of Inventive Composite Siding Product

Additional testing for fire resistance was conducted on siding products formed from the inventive composition set forth in Table 2 utilizing ASTM E84 (Standard Test Method for Surface Burning Characteristics of Building Materials). In accordance with ASTM E84 standard testing procedures, the test was conducted in a tunnel approximately 2 ft wide by 24 ft long. The tunnel contained two gas burners at one end that directed a flame onto the surface of the siding product being tested under a controlled air flow. Inventive composite siding, commercial siding products, and cedar were cut to 23.5 inches in length and laid in the tunnel as if they were being installed, with an approximate 1 inch overlap. The distance that the flames traveled and the rate at which the flame front advanced during a ten minute exposure were used to calculate the flame spread index. The smoke developed index was determined using a photometer system mounted at the exhaust end of the tunnel to monitor changes in the attenuation of incident light due to the passing smoke, particulate, and other effluent.

The index for each material was determined by comparing its performance with that of fiber/cement board and select grade red oak flooring, which were arbitrarily established as 0 and 100, respectively. Materials with a flame spread index of 0-25 were considered Class I or A. Class II (B) materials had an index between 26 and 75, and Class III (C) materials had an index of 76 or higher. Like the fiber/cement siding products, the inventive composite siding product demonstrated a Class I (A) fire rating. The results of the tests are set forth in Table 7.

TABLE 7
ASTM E84

| | Flame | Smoke | |
|---|---|---|---|
| | Spread | Developed | |
| Sample | Index | Index | Classification |
| Example 1⁽¹⁾ | 5 | 0 | I (A) |
| Example 2⁽²⁾ | 110 | 115 | III (C) |
| Example 3⁽³⁾ | 5 | 0 | I (A) |
| Example 4⁽⁴⁾ | 70 | 95 | II (B) |
| Inventive Composite | 20 | 35 | I (A) |
| Siding | | | |

⁽¹⁾fiber/cement siding product
⁽²⁾oriented strand board formed of wood chips and polymer binders
⁽³⁾fiber/cement siding product
⁽⁴⁾cedar flooring product

### Example 3—Mat Reinforced Polymer Gypsum Panels

Mat reinforced polymer gypsum panels were prepared by first forming a polymer/gypsum slurry formed of a-gypsum, a polyacrylic latex emulsion, a silane coupling agent, melamine-formaldehyde, and an accelerator (ammonium sulfate) in accordance with the weight percentages set forth in Table 8. The dry components (α-gypsum, melamine formaldehyde, and ammonium sulfate) were dry mixed in a container. The wet components (the polyacrylic latex emulsion and silane coupling agent) were mixed in a mixing container. The dry components were added gradually to the mixing container until the components were fully mixed. The resulting polymer/gypsum slurry was used to manufacture 12″×12″ fiber reinforced panels that included between 1 to 5 layers of Owens Corning's 1.95 lb./ft² shingle mat. The physical properties of the various panels are shown in Table 9.

TABLE 8

| | Weight | |
|---|---|---|
| Component | (grams) | Weight % |
| α-gypsum | 330 | 48.74 |
| acrylic latex emulsion | 230 | 33.97 |
| melamine-formaldehyde | 33 | 4.87 |
| accelerator⁽¹⁾ | 2.2 | 0.32 |
| silane coupling agent | 0.8 | 0.12 |
| glass fibers | 81 | 11.96 |
| Total | 677 | 100 |

⁽¹⁾ammonium sulfate

TABLE 9

| | Mat | | | | | |
|---|---|---|---|---|---|---|
| | reinforced | | | | | |
| | polymer | Panel | | | | |
| | panels | wt. | Mat wt | % glass | Thickness | Panel wt. |
| | # of plies | (grams) | (grams) | (wt) | (in) | (oz/ft²) |
| Panel 1 | 1 | 213 | 11 | 5.2 | 0.06 | 7.5 |
| Panel 2 | 2 | 331 | 20.3 | 6.1 | 0.09 | 11.7 |
| Panel 3 | 3 | 500 | 29.5 | 5.9 | 0.13 | 17.7 |
| Panel 4 | 5 | 740 | 49.5 | 6.7 | 0.21 | 26.1 |
| Panel 5 | 1 | 448 | 10.5 | 2.3 | 0.28 | 15.8 |

Two-ply and three-ply inventive mat reinforced polymer panels were tested for various mechanical properties, including tensile strength (ASTM D638), tensile modulus (ASTM D638), and Izod impact strength (unnotched) (ASTM D4812). These two- and three-ply glass mat reinforced polymer panels were also tested for water absorption following the testing procedures set forth in ASTM D570. The results of the mechanical testing are set forth in Table 10.

TABLE 10

| | | | | 2 ply glass | 3 ply glass |
|---|---|---|---|---|---|
| | | | ⅝ inch | reinforced | reinforced |
| Test | | | conventional | polymer | polymer |
| Method | Property | Units | drywall | panels | panels |
| | Thickness | Inches | 0.625 | 0.090 | 0.130 |
| ASTM | Tensile | psi | 302 | 2,389 | 3,897 |
| D638 | Strength | | | | |
| ASTM | Tensile | ksi | 4.30 | 1,288 | 1,312 |
| D638 | Modulus | | | | |
| ASTM | Izod Impact | in-lb | 0.483 | 3.076 | 4.257 |
| D4812 | (unnotched) | | | | |
| ASTM | Water | % | 44.6 | 1.6 | 1.5 |
| D570 | Absorption | | | | |

It can be concluded from Table 10 that the two- and three-ply glass reinforced polymer panels possessed a much larger tensile strength than the tested conventional drywall. In addition, the glass reinforcement in the inventive panels caused a vast increase in the impact strengths of the inventive panels over the tested conventional drywall. Further, as the amount of plies of the glass mats increased from two to three plies, the tensile strengths substantially increased. It is believed that as more glass mats are added to the glass reinforced polymer panels in a layered fashion, the impact resistance of the inventive panel will continue to increase. Additionally, it can be seen from Table 10 that both the two- and three-ply glass reinforced polymer panels absorbed significantly less water than the conventional drywall. This decrease in water absorption is significant in that the inventive polymer panels may be used in areas prone to receiving a lot of water, such as in a flood plain or a hurricane zone without ruining the panel. Also, it is to be noted that both the two- and three-ply glass reinforced polymer panels were thinner than the conventional drywall. One advantage provided by the thinness of the inventive panel is that more product may be transported at one time, thereby saving in transportation costs. Thus, it can be concluded from Table 10 that the inventive glass reinforced polymer panels have increased impact strength, improved tensile strength, and decreased water absorption in products that are thinner than conventional drywall.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

1. A wet fiber based composition for forming a glass reinforced gypsum composite product comprising:
wet glass fibers selected from the group consisting of wet used chopped strand glass fibers and wet continuous rovings;
gypsum; and
one or more water dispersible polymeric resin.

2. The wet fiber based composition of claim 1, further comprising at least one member selected from the group consisting of a filler material, at least one coupling agent, an organic acid, an accelerator, a hardener and a crosslinking polymer.

3. The wet fiber based composition of claim 2, wherein said crosslinking polymer is selected from the group consisting of melamine formaldehyde and urea formaldehyde, said accelerator is selected from the group consisting of aluminum sulfate, potassium sulfate and terra alba, and said hardener is selected from the group consisting of ammonium sulfate and ammonium chloride.

4. The wet fiber based composition of claim 3, wherein said polymeric resin is selected from the group consisting of polyacrylic emulsions, polyester emulsions, vinylacetate emulsions, epoxy emulsions and phenolic based polymers.

5. The wet fiber based composition of claim 4, wherein said polymeric resin is a polyacrylic emulsion.

6. The wet fiber based composition of claim 2, wherein said gypsum is selected from the group consisting of α-gypsum, β-gypsum and combinations thereof.

7. The wet fiber based composition of claim 1, wherein said wet glass fibers are present in said composition in an amount from about 1.0% to about 25% by weight of the active solids, said gypsum is present in said composition in an amount from about 30% to 70% by weight of the active solids, and said one or more water dispersible polymer is present in said composition in an amount from about 4.0% to about 40% by weight of the active solids.

8. A glass fiber reinforced gypsum composite product comprising:
a molded wet fiber based composition, said molded wet fiber based composition having a predetermined shape, said composition including:
wet glass fibers selected from the group consisting of wet used chopped strand glass fibers and wet continuous rovings;
gypsum; and
one or more water dispersible polymeric resin.

9. The glass fiber reinforced gypsum composite product of claim 8, wherein said wet fiber based composition further includes at least one member selected from the group consisting of a filler material, at least one coupling agent, an organic acid, an accelerator, a hardener, melamine formaldehyde and urea formaldehyde.

10. The glass fiber reinforced gypsum composite product of claim 8, wherein said one or more water dispersible polymeric resin is selected from the group consisting of polyacrylic emulsions, polyester emulsions, vinylacetate emulsions, epoxy emulsions and phenolic based polymers.

11. The glass fiber reinforced gypsum composite product of claim 8, wherein said molded wet fiber based composition has at least one major side, said at least one major side having a patterned surface.

12. The glass fiber reinforced gypsum composite product of claim 8, wherein said molded wet fiber based composition has at least one major side, said at least one major side has a post fabrication coating to enhance aesthetics or weatherability of said molded wet fiber based composition.

13. The glass fiber reinforced gypsum composite product of claim 8, wherein said predetermined shape is a board-like shape and said wet glass fibers are wet used chopped strand glass fibers,
wherein said wet used chopped strand glass fibers are substantially evenly distributed throughout said molded wet fiber based composition.

14. A thin glass reinforced gypsum drywall material comprising:
two or more polymer/gypsum layers; and
at least one wet glass fiber layer interposed between said at least two or more polymer/gypsum layers.

15. The thin glass reinforced gypsum drywall material of claim 14, wherein said two or more polymer/gypsum layers include at least one water dispersible polymer and said gypsum is selected from the group consisting of α-gypsum, β-gypsum and combinations thereof.

16. The thin glass reinforced gypsum drywall material of claim 15, wherein said at least one, glass fiber layer is a wet formed mat that includes wet used chopped strand fibers.

17. The thin glass reinforced gypsum drywall material of claim 16, wherein said wet formed mat has a weight of between about 0.5 and about 5.0 lb/100 sq. ft.

18. The thin glass reinforced gypsum drywall material of claim 14, wherein said polymer/gypsum layer further comprises at least one member selected from the group consisting of a filler material, at least one coupling agent, an organic acid, an accelerator, a hardener, melamine formaldehyde and urea formaldehyde.

19. The thin glass reinforced gypsum drywall material of claim 18, wherein said drywall material has at least one major side, said at least one major side having a patterned surface.

20. The thin glass reinforced gypsum drywall material of claim 14, wherein said drywall material is fire and water resistant.

21. The glass fiber reinforced gypsum composite product of claim 8, wherein said product is a siding product.

22. The glass fiber reinforced gypsum composite product of claim 21, wherein said wet glass fibers are wet used chopped strand glass fibers, and wherein said wet used chopped strand glass fibers are substantially evenly distributed throughout said siding product.

23. The glass fiber reinforced gypsum composite product of claim 21, wherein said siding product has at least one major side, said at least one major side having a post fabrication coating to enhance aesthetics or weatherability of said siding product.

24. The glass fiber reinforced gypsum composite product of claim 21, wherein said siding product is water resistant.

25. A reinforced siding product comprising:
wet glass fibers selected from the group consisting of wet used chopped strand glass fibers and wet continuous rovings;
gypsum; and
one or more water dispersible polymeric resin.

26. The reinforced siding product of claim 25, wherein said reinforced siding product has at least one major surface, said at least one major surface having a post fabrication coating to enhance aesthetics or weatherability of said siding product.

27. The reinforced siding product of claim 25, wherein said siding product is Class A fire resistant.

28. The reinforced siding product of claim 25, wherein said wet glass fibers are wet used chopped strand glass fibers, and
wherein said wet used chopped strand glass fibers are substantially evenly distributed throughout said siding product.

29. The reinforced siding product of claim 25, wherein said siding product further includes at least one member selected from the group consisting of a filler material, at least one coupling agent, an organic acid, an accelerator, a hardener, melamine formaldehyde and urea formaldehyde.

30. The reinforced siding product of claim 25, wherein said one or more water dispersible polymeric resin is selected from the group consisting of polyacrylic emulsions, polyester emulsions, vinylacetate emulsions, epoxy emulsions and phenolic based polymers.
